(19) United States
(12) Patent Application Publication
(10) Pub. No.: US 2011/0128270 A1
(43) Pub. Date: Jun. 2, 2011

(54) PLASMA DISPLAY DEVICE AND DRIVING METHOD THEREOF

(76) Inventors: Woo-Joon Chung, Yongin-si (KR); Tae-Jun Kim, Yongin-si (KR); Ji-Sun Kim, Yongin-si (KR)

(21) Appl. No.: 12/855,683

(22) Filed: Aug. 12, 2010

Related U.S. Application Data
(60) Provisional application No. 61/265,698, filed on Dec. 1, 2009.

(51) Int. Cl. G09G 5/00; G09G 3/28

(52) U.S. Cl. 345/211; 345/60

(57) ABSTRACT

A driving method of a plasma display device with reduced black luminance is provided. During at least one TV field without a main reset period, the at least one TV field including a first subfield and a second subfield having a reset waveform in a reset period of the first subfield and the second subfield, respectively, the method includes: applying a first scan low voltage or a first scan high voltage to a scan electrode during an address period of the first subfield; and applying a second scan low voltage or a second scan high voltage to the scan electrode during an address period of the second subfield, wherein the first and the second scan low voltages are maintained at a constant level for a period of time in the first and second subfields, respectively, and the first scan low voltage is different from the second scan low voltage.

### CROSS-REFERENCE TO RELATED APPLICATIONS

This application claims priority to and the benefit of U.S. Provisional Application No. 61/265,698, filed on Dec. 1, 2009, in the United States Patent and Trademark Office, the disclosure of which is incorporated herein in its entirety by reference.

### BACKGROUND

1. Field

Aspects of the present invention relate to a plasma display device and a driving method thereof.

2. Description of the Related Art

A plasma display device is a display device that displays text or images by using plasma generated by gas discharge. The plasma display device includes pixels of hundreds of thousands to millions or more depending on the size thereof. The pixels are arranged in a matrix form.

In the plasma display device, one frame (1 TV field) is driven by being divided into a plurality of sub-fields each having a weight. Each sub-field includes a reset period, an address period, and a sustain period.

The above information disclosed in this Background section is only for enhancement of understanding of the background of the invention, and therefore it may contain information that does not form the prior art that is already known in this country to a person of ordinary skill in the art.

### SUMMARY

Embodiments of the present invention provide a plasma display device capable of lowering black luminance and generating stable address discharge, and a driving method thereof.

One embodiment of the present invention provides a method of driving a plasma display panel including a scan electrode during at least one TV field without a main reset period, the at least one TV field including a first subfield and a second subfield having a reset waveform in a reset period of the first subfield and the second subfield, respectively, the method includes: applying a first scan low voltage or a first scan high voltage to the scan electrode during an address period of the first subfield; and applying a second scan low voltage or a second scan high voltage to the scan electrode during an address period of the second subfield, wherein the first and the second scan low voltages are maintained at a constant level for a period of time in the first and second subfields, respectively, and wherein the first scan low voltage is different from the second scan low voltage.

The first scan low voltage may be applied before the second scan low voltage and may be lower than the second scan low voltage.

The first scan low voltage may be applied before the second scan low voltage and may be higher than the second scan low voltage.

A lowest voltage of the reset waveform in the first subfield may be different from a lowest voltage of the reset waveform in the second subfield.

The first subfield may be applied before the second subfield, and the lowest voltage of the reset waveform of the first subfield may be lower than the lowest voltage of the reset waveform of the second subfield.

The first subfield may be applied before the second subfield, and the lowest voltage of the reset waveform of the first subfield may be higher than the lowest voltage of the reset waveform of the second subfield.

The method may further include applying a main reset waveform during a reset period of a subfield of another TV field that is applied before the at least one TV field.

All scan low voltages applied during subfields of the another TV field may be substantially identical to each other.

Another embodiment of the present invention provides a method of driving a plasma display panel including a scan electrode during at least a first TV field including a first subfield having a main reset waveform in a reset period of the first subfield and a second subfield having an auxiliary reset waveform in a reset period of the second subfield, and a second TV field including a third subfield and a fourth subfield having the auxiliary reset waveform in a reset period of the third subfield and the fourth subfield, respectively. The method includes: applying a first scan low voltage or a first scan high voltage to the scan electrode during an address period of the third subfield; and applying a second scan low voltage or a second scan high voltage to the scan electrode during an address period of the fourth subfield, wherein the first and the second scan low voltages are maintained at a constant level for a period of time in the third and fourth subfields, respectively, and wherein the first scan low voltage is different from the second scan low voltage.

A lowest voltage of the main reset waveform may be the same as a lowest voltage of the auxiliary reset waveform.

A lowest voltage of the main reset waveform may be different from a lowest voltage of the auxiliary reset waveform.

A lowest voltage of the main reset waveform may be substantially the same as the first scan low voltage.

A lowest voltage of the main reset waveform may be substantially the same as the second scan low voltage.

The main reset waveform may be applied at least once in one TV field for at least every two TV fields.

The main reset waveform may include a rising waveform and the auxiliary reset waveform may not include a rising waveform.

### BRIEF DESCRIPTION OF THE DRAWINGS

FIG. 1 is a schematic block diagram of a plasma display device according to an exemplary embodiment of the present invention;

FIG. 2 is a diagram showing driving waveforms of a plasma display device according to one embodiment of the present invention;

FIG. 3 is a graph showing a loss amount of a wall voltage in respect to a frequency of applying an auxiliary reset pulse;

FIG. 4 is a diagram showing driving waveforms of a plasma display device according to another embodiment of the present invention; and

FIG. 5 is a diagram showing driving waveforms of a plasma display device according to yet another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

The reset period is a period for initializing the state of all cells so as to allow an addressing operation to be smoothly performed in the cells. Reset operates to prepare the cell to satisfy an address condition of a current sub-field regardless of an on or off state of the cell in the previous sub-field. When all the cells are reset, white light is emitted, and therefore black luminance becomes very high in a case where all sub-fields include the reset period. Here, the black luminance is panel luminance measured when a discharge cell is in an off state.

The address period is a period in which turn-on cells (on cell) and turn-off cells (off cell) are selected in a panel. An on cell is selected by accumulating a wall charge in the discharge cell by applying an address voltage to the discharge cell. The sustain period is a period in which discharge for actually displaying an image on an addressed cell is performed by applying a sustain discharge pulse to the addressed cell.

During the address period, in order to select a discharge cell that will emit light, in a state where a set voltage (i.e., Ve) is applied to a sustain electrode (X electrode), a scan pulse having a voltage value of VscL is sequentially applied to a scan electrode (Y electrode). Here, an address voltage Va is applied to an address electrode (A electrode) that passes through the discharge cell that will emit light among discharge cells formed by the scan electrode applied with the scan pulse and the sustain electrode. Then, address discharge is generated between the address electrode applied with the address voltage Va and the scan electrode applied with the voltage VscL and between the scan electrode applied with the voltage VscL and the sustain electrode applied with the voltage Ve, such that a positive (+) wall charge is formed on the scan electrode and a negative (−) wall charge is formed on the sustain electrode.

Here, in a first stage of the address period, a large amount of accumulated wall charges is formed during the reset period, such that when an address discharge pulse is applied to the scan electrode and the address electrode, address discharge is easily generated. However, as time passes after the reset period, recombination occurs between the positive (+) wall charge and the negative (−) wall charge, such that the wall charges formed during the reset period are gradually lost. Therefore, as time elapses, when the voltage VscL is applied to the scan electrode and the voltage Va is applied to the address electrode, since the wall charge is lost, almost no address discharge is generated.

Further, the display device may be driven in a scheme in which a main reset pulse is applied only in any one sub-field (alternatively, in one or more sub-fields) of several sub-fields constituting the 1 TV field and an auxiliary reset pulse is applied in the other sub-fields. This is referred to as a selective reset scheme.

In the selective reset scheme, a reset discharging all cells is referred to as a main reset, and a reset discharging only a cell which was previously turned on is referred to as an auxiliary reset. Typically, the 1 TV field includes a one-time main reset in one sub-field and auxiliary resets in the other sub-fields. A main reset pulse is constituted by a rising reset pulse and a falling reset pulse, and reset-discharges all discharge cells. The auxiliary reset pulse is constituted by only the falling reset pulse.

In case of driving the plasma display device by using the main reset pulse and the auxiliary reset pulse for the 1 TV field, the above-mentioned wall charge is lost as time passes after the main reset pulse is applied. In addition, since all the discharge cells are not reset-discharged by subsequently applied auxiliary reset pulses, the wall charge is severely lost in discharge cells that are not initialized by the auxiliary reset pulse.

That is, in case of driving the plasma display device by using the main reset pulse and the auxiliary reset pulse, the address discharge becomes more unstable than in a case in which the main reset pulse is applied in each sub-field.

Further, even in the case of using the selective reset scheme, the problem of increased black luminance due to the main reset still exists.

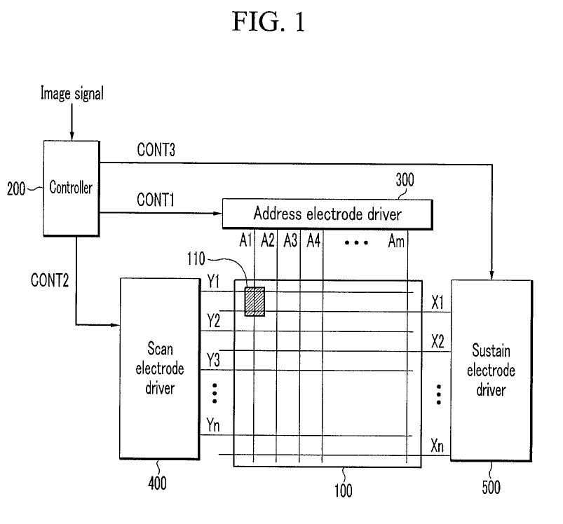

FIG. 1 is a schematic block diagram of a plasma display device according to an exemplary embodiment of the present invention.

Referring to FIG. 1, the plasma display device includes a plasma display panel 100, a controller 200, an address electrode driver 300, a scan electrode driver 400, and a sustain electrode driver 500.

The plasma display panel 100 includes a plurality of display electrodes Y1 to Yn and X1 to Xn, a plurality of address electrodes (hereinafter referred to as “A electrodes”) A1 to Am, and a plurality of discharge cells 110.

The plurality of display electrodes Y1 to Yn and X1 to Xn include a plurality of scan electrodes (hereinafter referred to as “Y electrodes”) Y1 to Yn and a plurality of sustain electrodes (hereinafter referred to as “X electrodes”) X1 to Xn. The Y electrodes Y1 to Yn and the X electrodes X1 to Xn extend substantially in a row direction and are substantially parallel to each other. The A electrodes A1 to Am extend substantially in a column direction and are substantially parallel to each other. The Y electrodes Y1 to Yn and the X electrodes X1 to Xn may correspond to each other one by one. Alternatively, two X electrodes X1 to Xn may correspond to one Y electrode Y1 to Yn or two Y electrodes Y1 to Yn may correspond to one X electrode X1 to Xn. Discharge cells 110 are formed in spaces defined by the A electrodes A1 to Am, the Y electrodes Y1 to Yn, and the X electrodes X1 to Xn.

The above-described structure of the plasma display panel 100 is just one example, and according to embodiments of the present invention, the plasma display panel 100 may have another suitable structure.

The controller 200 receives a video signal (or image signal) and an input control signal for controlling display of the video signal. The video signal contains information on luminance of each discharge cell 110, and the luminance of each discharge cell 110 may be expressed as one of a set number of gray-levels. An example of the input control signal includes a vertical synchronization signal, a horizontal synchronization signal, etc.

The controller 200 divides one frame (1 TV field) of video into a plurality of sub-fields each having a luminance weight, and at least one of the sub-fields includes a reset period, an address period, and a sustain period. The controller 200 generates an A electrode driving control signal CONT1, a Y electrode driving control signal CONT2, and an X electrode driving control signal CONT3 by processing the video signal and the input control signal to be suitable for the plurality of sub-fields. In addition, the controller 200 outputs the A electrode driving control signal CONT1 to the address electrode driver 300, outputs the Y electrode driving control signal CONT2 to the scan electrode driver 400, and outputs the X electrode driving control signal CONT3 to the sustain electrode driver 500.

Further, the controller 200 converts the input video signal corresponding to each discharge cell into sub-field data representing emission/non-emission of each discharge cell 110 in the plurality of sub-fields, and the A electrode driving control signal CONT1 includes the sub-field data.

The scan electrode driver 400 sequentially applies a scan pulse having a low scan voltage level to the Y electrodes Y1 to Yn during the address period in accordance with the Y electrode driving control signal CONT2. The address electrode driver 300 applies an address pulse having an address voltage level for discriminating an on cell from an off cell to the A electrodes A1 to Am in the plurality of discharge cells connected to the Y electrode to which the scan pulse is applied in accordance with the A electrode driving control signal CONT1. When the on cell and the off cell are determined during the address period, the scan electrode driver 400 and the sustain electrode driver 500 alternately apply a sustain discharge pulse to the Y electrodes Y1 to Yn and the X electrodes X1 to Xn at a frequency corresponding to a luminance weight of each sub-field during the sustain period in accordance with the Y electrode driving control signal CONT2 and the X electrode driving control signal CONT3.

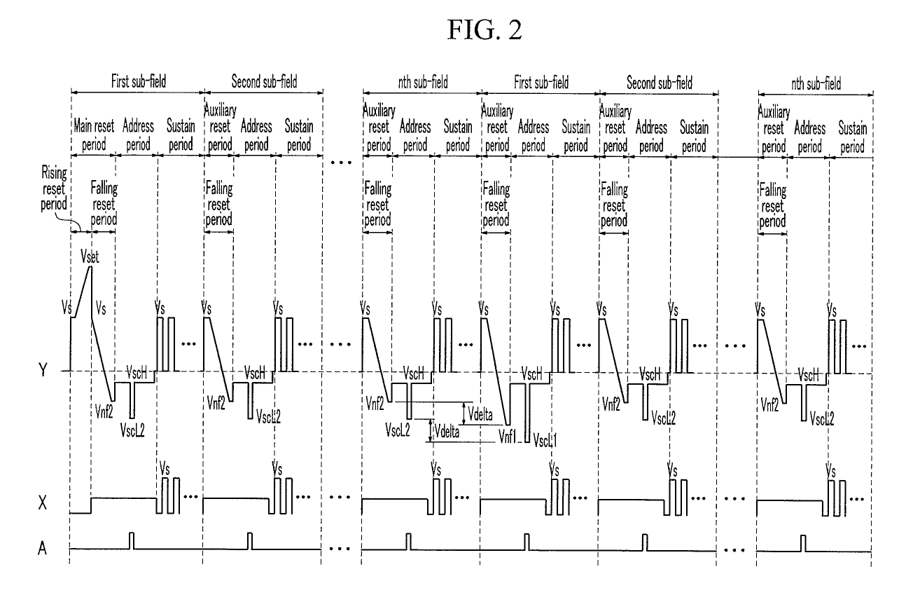

Hereinafter, referring to FIG. 2, driving waveforms of the plasma display device according to an embodiment of the present invention applied to the A electrodes A1 to Am, the Y electrodes Y1 to Yn, and the X electrodes X1 to Xn will be described in more detail.

Hereinafter, a reset period in which all discharge cells are initialized is defined as a main reset period, and a reset period constituted by only the falling reset period, in which a discharge cell (on cell) turned on for displaying an image in a previous subfield is initialized, is defined as an auxiliary reset period. Further, hereinafter, a driving waveform applied during the main reset period is referred to as a main reset pulse, and a driving waveform applied during the auxiliary reset period is referred to as an auxiliary reset pulse.

A plasma display device according to one exemplary embodiment of the present invention applies a driving waveform including a main reset pulse for every two or more TV fields. That is, in one embodiment of the present invention, only one of the sub-fields of two or more TV fields includes a main reset pulse, and each of the other sub-fields includes only an auxiliary reset pulse.

Further, the plasma display device according to one exemplary embodiment of the present invention applies a driving waveform including a different main reset that may substitute for the above-described main reset in one sub-field of each TV field. The different main reset may be implemented by setting a scan voltage of a sub-field (e.g., a predetermined sub-field) of the unit TV field to a value that is lower than scan voltages of other sub-fields by Vdelta. In one embodiment of the present invention, the scan voltage of the sub-field having a first weight in the TV field that does not comprise the main reset is set to a value that is lower than the scan voltages of other sub-fields by Vdelta as the different main reset, but the present invention is not limited thereto.

Referring to FIG. 2, one sub-field includes the reset period, the address period, and the sustain period for driving the plasma display device. Reset driving waveforms, address driving waveforms, and sustain driving waveforms shown in FIG. 2 are applied to the X, Y, and A electrodes during the periods, respectively.

As shown in FIG. 2, first, the main reset pulse is applied to the Y electrode during the main reset period of a first sub-field. During a rising period of the main reset period, voltages of the X electrode and the A electrode are maintained at a reference voltage, and a voltage of the Y electrode gradually increases from a voltage Vs to a voltage Vset. In FIG. 2, a case in which the reference voltage is a ground voltage (0V) is shown as an example. However, the reference voltage may not be the ground voltage (0V) but may be another suitable voltage. In addition, the reference voltage may be fixed to a set level (e.g., a predetermined level) or a variable level.

During the rising reset period of the main reset period, while the voltage of the Y electrode increases, weak discharge is generated between the Y electrode and the X electrode and between the Y electrode and the A electrode, such that a negative (−) wall charge is generated on the Y electrode and a positive (+) wall charge is generated on the X electrode and the A electrode.

During the falling reset period of the main reset period, in a state where the voltages of the A electrode and the X electrode are maintained at the reference voltage and a voltage Ve, respectively, the voltage of the Y electrode gradually decreases from the voltage Vs to a voltage Vnf2. Then, the negative (−) wall charge generated on the Y electrode and the positive (+) wall charge generated on the X electrode and the A electrode are removed by the weak discharge generated between the Y electrode and the X electrode and between the Y electrode and the A electrode while the voltage of the Y electrode decreases. In one embodiment, the magnitude of a voltage (Vnf2−Ve) is set to a value around a discharge starting voltage between the Y electrode and the X electrode. Then, the wall voltage between the Y electrode and the X electrode is approximately 0V, such that it is possible to prevent a cell in which address discharge is not generated during the address period from being mis-discharged during the sustain period.

During the address period of the first sub-field, in order to select a discharge cell to be turned on, in a state where the X electrode is maintained at the voltage Ve, a plurality of scan pulses having a second scan voltage Vscl2 that are applied in sequence or in an interlaced scheme to the plurality of Y electrodes Y1 to Yn. Concurrently, the address electrode driver 300 applies an address voltage Va to an A electrode passing the on cell of the plurality of discharge cells formed by the plurality of Y electrodes to which the second scan voltage VscL2 is applied.

As a result, the address discharge is generated in the discharge cell formed by the A electrode applied with the address voltage Va and the Y electrode applied with the second scan voltage VscL2, such that a positive charge may be generated on the Y electrode and a negative charge may be generated on each of the A electrode and the X electrode.

Further, the scan electrode driver 400 may apply a voltage VscH (non-scan voltage) that is higher than the second scan voltage VscL2 to the Y electrode during a period when the second scan voltage VscL2 is not applied, and the address electrode driver 300 may apply the ground voltage (0V) to the A electrode during a period when the address voltage Va is not applied. In one embodiment, the second scan voltage VscL2 may be a negative voltage, and the address voltage Va may be a positive voltage. In FIG. 2, a case in which the voltage VscH is the negative voltage is shown as an example, but the voltage VscH may be the positive voltage.

During the sustain period, the scan electrode driver 400 and the sustain electrode driver 500 apply a sustain discharge pulse alternately having a high voltage Vs and a low voltage (e.g., ground voltage) to the Y electrode and the X electrode in opposite phases. That is, when the high voltage Vs is applied to the Y electrode while the low voltage is applied to the X electrode, the sustain discharge is generated in the on cell by a voltage difference between the high voltage Vs and the low voltage, and then when the low voltage is applied to the Y electrode and the high voltage Vs is applied to the X electrode, the sustain discharge may again be generated in the on cell by the voltage difference between the high voltage Vs and the low voltage. The above-described operation is repeated during the sustain period, such that the sustain discharge is generated at a frequency corresponding to a luminance weight of the corresponding sub-field.

Unlike the above described embodiment, the high voltage of the sustain discharge pulse may be set to a voltage Vs/2 and the low voltage of the sustain discharge pulse may be set to a voltage −Vs/2. Alternatively, in a state where the ground voltage is applied to any one electrode (e.g., X electrode) of the Y electrode and the X electrode, the sustain discharge pulse alternately having the voltage Vs and the voltage −Vs may be applied to the other electrode (e.g., Y electrode).

A driving pulse of the second sub-field is continuously applied. In the second sub-field, only the auxiliary reset period, which is constituted only by the falling reset period and not the rising reset period, is included. During the auxiliary reset period, the driving waveforms applied to the X, Y, and A electrodes are the same as the driving waveforms during the falling reset period of the main reset period. Therefore, a detailed description thereof will be omitted.

During the address period of the second sub-field, in order to select a discharge cell to be turned on, in a state where the X electrode is maintained at the voltage Ve, the falling reset pulse having a second falling reset voltage Vnf2 and a plurality of second scan pulses having a second scan voltage VscL2 are applied in sequence or in an interlaced scheme to the plurality of Y electrodes Y1 to Yn. Concurrently, the address electrode driver 300 applies the address voltage Va to an A electrode passing the on cell of the plurality of discharge cells formed by the Y electrodes to which the second scan voltage VscL2 is applied.

Further, the reset period of each of sub-fields (for example, when the 1 TV field is constituted by 8 sub-fields, third to eighth sub-fields) following the second sub-field may be constituted by only the auxiliary reset period. In addition, during the address period of each of the sub-fields following the second sub-field, similar to the address period of the second sub-field, the second scan pulse having the second scan voltage VscL2 is applied.

During the sustain period of the second sub-field, the driving waveforms applied to the X, Y, and A electrodes are the same as the driving waveforms during the sustain period of the first sub-field. Therefore, a detailed description thereof will be omitted. Further, during the sustain period of each of the sub-fields following the second sub-field, the same driving waveforms as that during the sustain period of the second sub-field are applied.

In the plasma display device and the driving waveforms thereof according to one embodiment of the present invention, a first falling reset voltage Vnf1 of an auxiliary reset pulse in a first sub-field of the second TV field has a value that is lower than the second falling reset voltage Vnf2 and a first scan voltage VscL1 of the scan pulse in an address period of the first sub-field of the second TV field has a value that is lower than the second scan voltage VscL2 by the voltage Vdelta.

However, the present invention is not limited to setting the voltage difference between the second falling reset voltage Vnf2 and the first falling reset voltage Vnf1 and the voltage difference between the first scan voltage VscL1 and the second scan voltage VscL2 to the same value. The two voltage differences may be set to different values in other embodiments.

The first falling reset voltage Vnf1 is set lower than the second falling reset voltage Vnf2 to serve to reset the cell such that the address discharge is stably generated in a wider dimension.

The first scan voltage VscL1 is set to a lower voltage than the second scan voltage VscL2 to increase a voltage difference between the Y electrode and the A electrode and a voltage difference between the Y electrode and the X electrode during the address period of the corresponding sub-field (e.g., first sub-field of the second TV field of FIG. 2). Accordingly, the address discharge may be stably generated during the address period following the main reset period.

Further, although the main reset pulse is applied in only one or some sub-fields and the auxiliary reset pulse is applied in the reset sub-fields without constituting each of reset periods of a plurality of sub-fields constituting one TV field by the main reset period, it is possible to solve problems of loss of the wall charge generated due to time delay and the resulting unstable generation of the address discharge.

As described above, when the reset period of each of the sub-fields is constituted by the main reset period, all the discharge cells are reset in each sub-field. Therefore, white light is emitted by the resets in all the discharge cells, and as a result, black luminance becomes very high. As the black luminance in the plasma display device has a smaller value, the color expression ability of the plasma display device increases. However, when the reset period of each of the sub-fields is constituted by the main reset period, the black luminance is increased and the color expression ability is deteriorated by the emitted white light.

In the plasma display device and the driving method thereof according to one embodiment of the present invention, not every one of the reset periods of the plurality of sub-fields constituting at least 2 TV fields includes the main reset period. That is, the main reset period is included in only one or some sub-fields of one TV field of at least two TV fields, and each of the reset periods of the other sub-fields is constituted by the auxiliary reset period.

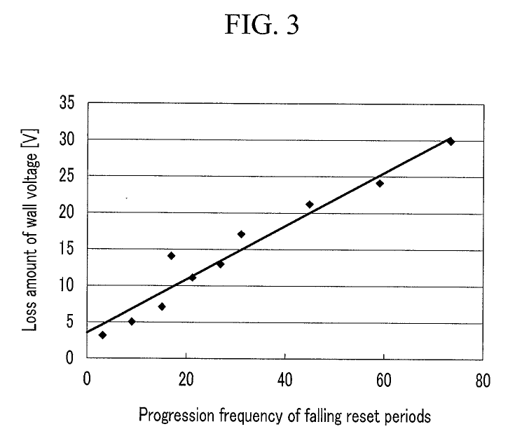

In order to minimize the resulting loss of the wall voltage between the address electrode and the scan electrode and strengthen the address discharge, the first falling reset voltage Vnf1 is set to a value that is lower than the second falling reset voltage Vnf2, and the first scan voltage VscL1 is set to a value that is lower than the second scan voltage VscL2 by the voltage Vdelta. The setting of the value of the Vdelta will be described below with reference to FIG. 3.

The driving waveforms of the plasma display device according to another embodiment of the present invention may apply the main reset period in different phases for each group by grouping a plurality of scan electrodes into at least two scan electrode groups, e.g., odd- and even-numbered scan electrodes groups, while including the main reset period at one time only for several TV fields.

Then, the main reset period is scattered in time so as to lower the black luminance and solve a problem of screen flickering (back flicker) caused by white light emitted during the main reset period.

Herein, the value of Vdelta will be described in more detail with reference to FIG. 3.

FIG. 3 is a graph showing a loss amount of a wall voltage with respect to a frequency to apply an auxiliary reset pulse.

Referring to FIG. 3, the X axis represents a progression frequency of a falling reset period and the Y axis represents a loss amount of a wall voltage between an A electrode and a Y electrode with respect to the progression frequency of the falling reset period. Since the magnitude of the voltage depends on charge quantity, the loss amount of the wall voltage corresponds to the loss amount of the wall charge.

At least one falling reset period exists in one sub-field, and one or more falling reset periods may exist depending on a product specification of the plasma display device.

For example, it is assumed that two falling reset periods exist in one sub-field, and the 1 TV field is constituted by 10 sub-fields. In addition, it is assumed that only one main reset period exists in the 1 TV field. Then, the wall charge formed through one main reset period passes 19 falling reset periods (since one of a total of 20 is the falling reset period included in the main reset period, the frequency (e.g., counts) of the falling reset periods except for the main reset period is 19 times) and address periods corresponding to the 19 falling reset periods.

Referring to FIG. 3, as the frequency of the falling reset periods increases, the loss amount of the wall voltage linearly increases. The actual loss amount of the wall voltage has a value that is dependent on the product specification of the plasma display device, and may be experimentally acquired. As a result, the value of Vdelta is determined by considering the loss amount of the wall voltage with respect to the progression frequency of the falling reset periods for each model of the plasma display device.

Referring to FIG. 3, when the falling reset period is repeated at 20 times, the loss amount of the wall voltage is 15V at a maximum. In the plasma display device in which the loss amount of the wall voltage with respect to the progression frequency of the falling reset periods has a characteristic value illustrated in the graph of FIG. 3, when the falling reset period is repeated 20 times in the 1 TV field, Vdelta may be set to 15V in the plasma display device and the driving method thereof according to one embodiment of the present invention, which is shown in FIG. 3. In this case, during a next TV field without the main reset, the first scan voltage VscL1 in the address period of a sub-field including the different main reset is set to a lower value than the second scan voltage VscL2 by 15V. Then, the loss of the wall charge generated as the falling reset period is repeated 20 times may be compensated for. Therefore, stable address discharge may be generated.

Further, when the driving waveform (the driving waveform in the first sub-field of FIG. 2) having the main reset period in two or more sub-fields in the 1 TV field is applied, the value of Vdelta is set by considering the frequency of consecutive auxiliary reset periods following the main reset period and the loss amount of the wall charge corresponding to the frequency.

A different main reset is included in the first sub-field of the TV field without the main reset in the above embodiment. However, according to another embodiment, the different main reset may be included in at least one of other sub-fields of the TV field without the main reset.

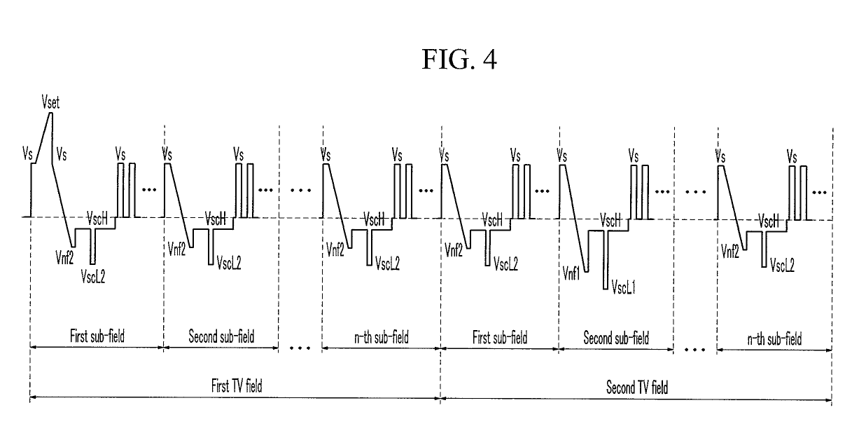

FIG. 4 is a diagram showing a driving waveform of a plasma display device according to another embodiment of the present invention.

As shown in FIG. 4, the different main reset is included in a second sub-field of a second TV field.

A falling reset voltage in a reset period of the second sub-field of the second TV field corresponding to the different main reset is the first falling reset voltage Vnf1. A scan low voltage in an address period of the second sub-field is the first scan voltage VscL1.

In the second TV field, a falling reset voltage in a reset period of a first sub-field is the second falling reset voltage Vnf2, and a scan low voltage in an address period of the first sub-field is the second scan voltage VscL2.

In addition, according to yet another embodiment, a falling reset voltage of a main reset pulse may be set to the first falling reset voltage Vnf1 and a scan low voltage in an address period of a subfield including the main reset period may be set to the first scan voltage VscL1.

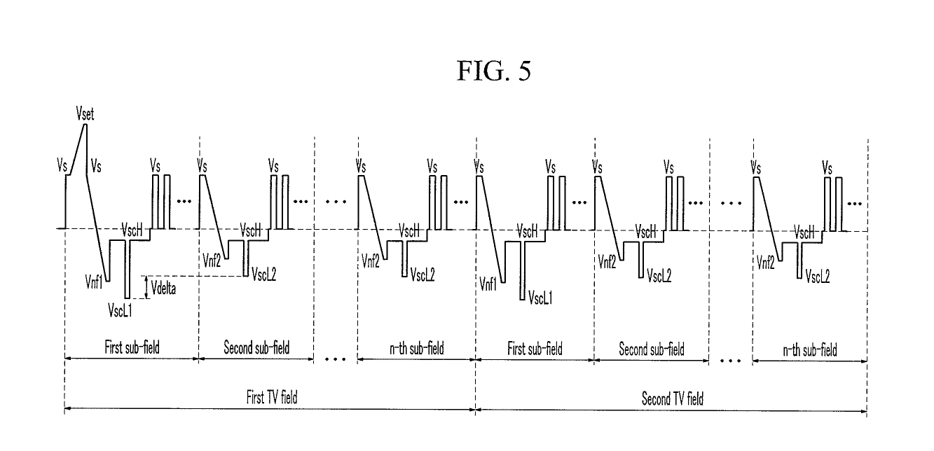

FIG. 5 is a diagram showing a driving waveform of a plasma display device according to yet another embodiment of the present invention.

As shown in FIG. 5, the main reset pulse in the main reset period of the first sub-field decreases to the first falling voltage Vnf1, and the scan pulse in the address period of the first sub-field has the first scan voltage VscL1.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method of driving a plasma display panel comprising a scan electrode during at least one TV field without a main reset period, the at least one TV field comprising a first subfield and a second subfield having a reset waveform in a reset period of the first subfield and the second subfield, respectively, the method comprising:
applying a first scan low voltage or a first scan high voltage to the scan electrode during an address period of the first subfield; and
applying a second scan low voltage or a second scan high voltage to the scan electrode during an address period of the second subfield,
wherein the first and the second scan low voltages are maintained at a constant level for a period of time in the first and second subfields, respectively, and
wherein the first scan low voltage is different from the second scan low voltage.

2. The method of claim 1, wherein the first scan low voltage is applied before the second scan low voltage and is lower than the second scan low voltage.

3. The method of claim 1, wherein the first scan low voltage is applied before the second scan low voltage and is higher than the second scan low voltage.

4. The method of claim 1, wherein a lowest voltage of the reset waveform in the first subfield is different from a lowest voltage of the reset waveform in the second subfield.

5. The method of claim 4, wherein the first subfield is applied before the second subfield, and the lowest voltage of the reset waveform of the first subfield is lower than the lowest voltage of the reset waveform of the second subfield.

6. The method of claim 4, wherein the first subfield is applied before the second subfield, and the lowest voltage of the reset waveform of the first subfield is higher than the lowest voltage of the reset waveform of the second subfield.

7. The method of claim 1, further comprising applying a main reset waveform during a reset period of a subfield of another TV field that is applied before the at least one TV field.

8. The method of claim 7, wherein all scan low voltages applied during subfields of the another TV field are substantially identical to each other.

9. A method of driving a plasma display panel comprising a scan electrode during at least a first TV field comprising a first subfield having a main reset waveform in a reset period of the first subfield and a second subfield having an auxiliary reset waveform in a reset period of the second subfield, and a second TV field comprising a third subfield and a fourth subfield having the auxiliary reset waveform in a reset period of the third subfield and the fourth subfield, respectively, the method comprising:
applying a first scan low voltage or a first scan high voltage to the scan electrode during an address period of the third subfield; and
applying a second scan low voltage or a second scan high voltage to the scan electrode during an address period of the fourth subfield,
wherein the first and the second scan low voltages are maintained at a constant level for a period of time in the third and fourth subfields, respectively, and
wherein the first scan low voltage is different from the second scan low voltage.

10. The method of claim 9, wherein a lowest voltage of the main reset waveform is the same as a lowest voltage of the auxiliary reset waveform.

11. The method of claim 9, wherein a lowest voltage of the main reset waveform is different from a lowest voltage of the auxiliary reset waveform.

12. The method of claim 9, wherein a lowest voltage of the main reset waveform is substantially the same as the first scan low voltage.

13. The method of claim 9, wherein a lowest voltage of the main reset waveform is substantially the same as the second scan low voltage.

14. The method of claim 9, wherein the main reset waveform is applied at least once in one TV field for at least every two TV fields.

15. The method of claim 9, wherein the main reset waveform comprises a rising waveform and the auxiliary reset waveform does not comprise a rising waveform.
